(19) United States
(12) Patent Application Publication
(10) Pub. No.: US 2016/0063158 A1
(43) Pub. Date: Mar. 3, 2016

(54) METHOD AND DEVICE FOR SIMULATING A CIRCUIT DESIGN

(71) Applicant: International Business Machines Corporation, Armonk, NY (US)

(72) Inventors: Peng Fei Gou, Shanghai (CN); De Xian Li, Shanghai (CN); Yu Fei Li, Shanghai (CN); Yang Liu, Shanghai (CN); Peng Ou, Shanghai (CN)

(21) Appl. No.: 14/748,980

(22) Filed: Jun. 24, 2015

(30) Foreign Application Priority Data
Aug. 29, 2014 (CN) 201410437455.X

(51) Int. Cl. G06F 17/50

(52) U.S. Cl. CPC G06F 17/5036; G06F 17/5022

(57) ABSTRACT

The present invention discloses a method and device for simulating a circuit design. The method includes identifying at least one Sequential-cell-To-Sequential-cell (S2S) block in the circuit design, wherein the S2S block includes at least one input sequential cell, at least one output sequential cell, and an intermediate portion between the input sequential cell and the output sequential cell, wherein the intermediate portion includes at least one combinational cell; determining logic characteristics and timing characteristics of the intermediate portion; and replacing the intermediate portion with a functional module having the logic characteristics and the timing characteristics to generate a simplified circuit design to be used in simulation. With the technical solution according to embodiments of the invention, time needed in simulation is shortened.

### BACKGROUND

The present invention relates to integrated circuit design technology, and more specifically, to a method and device for simulating a circuit design.

In modern integrated circuit design flow, an EDA tool is required for simulation of an integrated circuit design. Simulation takes up to 70% of the total design cycle. During simulation, characteristics of respective circuit cells in the circuit need to be simulated. The circuit cells here not only include respective functional modules in the circuit, but also include interconnections among the functional modules. The characteristics include logic characteristics and timing characteristics. The logic characteristics refer to relationship between input and output of the circuit cells, and the timing characteristics refer to time-dependent characteristics such as delay, setup time and hold time of the circuit cells. The characteristics of a circuit cell are typically stored in an annotation associated with that circuit cell.

Those skilled in the art can appreciate that, on one hand, the more comprehensive in consideration of characteristics of each circuit cell, the more accurate the obtained verification result, and the more authentic in reflecting actual condition of the integrated circuit; on the other hand, the more comprehensive in consideration of characteristics of each circuit cell, the more computational amount will be caused during simulation. In particular, for gate level netlist simulation, due to the huge number of cells, increase in computational amount caused by giving consideration to one more characteristic is very impressive.

Generally speaking, logic characteristics of a circuit cell are basic characteristics which need to be considered during simulation. FIG. 2 shows simulation time needed in simulating a same circuit design when timing characteristics are considered and when timing characteristics are not considered. As can be seen, when timing characteristics are considered, the time needed in simulation is more than 50 times of the time needed in simulation when timing characteristics are not considered.

Thus, there is a need for a method to reduce simulation time needed when timing characteristics of circuit cells are considered.

### SUMMARY

According to one aspect of the present invention, there is provided a method for simulating a circuit design, comprising: identifying at least one Sequential-cell-To-Sequential-cell (S2S) block in the circuit design, wherein the S2S block includes at least one input sequential cell, at least one output sequential cell, and an intermediate portion between the input sequential cell and the output sequential cell, and wherein the intermediate portion includes at least one combinational cell; determining logic characteristics and timing characteristics of the intermediate portion; and replacing the intermediate portion with a functional module having the logic characteristics and the timing characteristics to generate a simplified circuit design to be used in simulation.

According to another aspect of the present invention, there is provided a device for simulating a circuit design, comprising: an identifying means configured to identify at least one Sequential-cell-To-Sequential-cell (S2S) block in the circuit design, wherein the S2S block includes at least one input sequential cell, at least one output sequential cell, and an intermediate portion between the input sequential cell and the output sequential cell, and wherein the intermediate portion includes at least one combinational cell; a characteristic determining means configured to determine logic characteristics and timing characteristics of the intermediate portion; and a simplifying means configured to replace the intermediate portion with a functional module having the logic characteristics and the timing characteristics to generate a simplified circuit design to be used in simulation.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement the embodiments of the present invention;

FIG. 2 shows time needed in simulation;

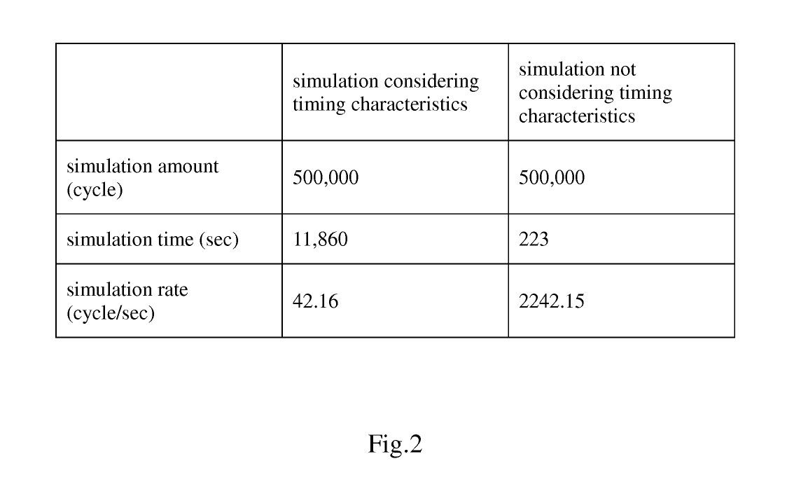

FIG. 3 shows a flowchart of a method for simulating a circuit design according to an embodiment of the present invention;

FIGS. 4A and 4B show exemplary S2S blocks;

FIGS. 5A and 5B show an event list during simulation;

FIG. 6 shows a flowchart of a method for simulating a circuit design according to an embodiment of the present invention;

FIGS. 7A, 7B and 7C show exemplary S2S blocks; and

FIG. 8 shows a block diagram of a device for simulating a circuit design according to an embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

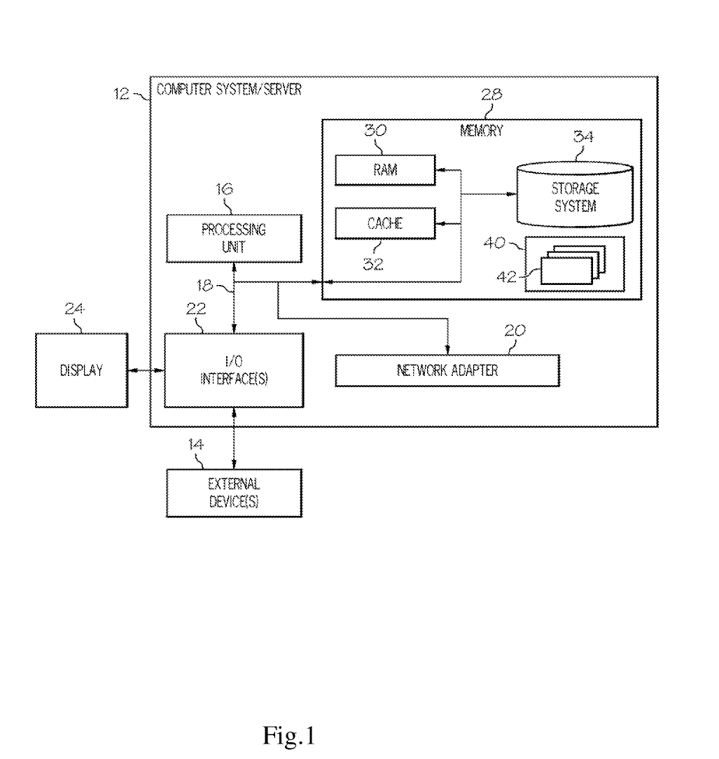

Referring now to FIG. 1, in which a block diagram of an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

As described above, as compared to simulation where timing characteristics of circuit cells are not considered, simulation where timing characteristics of circuit cells are considered needs to consume much more time. For every circuit cell, processing needs to be performed on timing characteristics thereof, which at least comprising: obtaining information about the timing characteristics thereof, and computing an output signal in combination with the information and input signal(s). In particular, for a circuit cell having a plurality of inputs, signal change at each input thereof will be regarded as an event, thus triggering a simulation directed to that circuit cell. These signals often arrive at that circuit cell through different paths, thus change may occur at different times. These changes occurring at different times are regarded as a plurality of events, which lead to a plurality of simulations directed to that circuit cell. Only after completion of simulation triggered by a previous event, can a simulator know whether a new time node needs to be inserted, which in turn would lead to a plurality of insert operations.

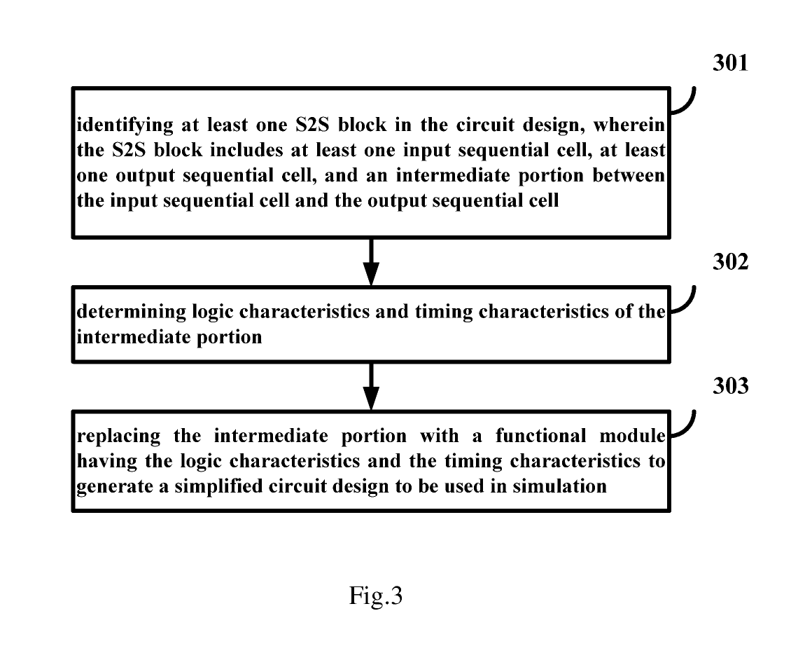

A method for simulating a circuit design according to an embodiment of the present invention will be described below with reference to FIG. 3.

Step 301: identifying at least one Sequential-cell-To-Sequential-cell (S2S) block in the circuit design, wherein the S2S block includes at least one input sequential cell, at least one output sequential cell, and an intermediate portion between the input sequential cell and the output sequential cell.

In the following description, a register is taken as an example of the sequential cell. Those skilled in the art will appreciate that, the sequential cell may include a register, a latch, a trigger, and so on.

Those skilled in the art will appreciate that, register in a digital circuit plays a role of stabilizing signals. The register at an input of the S2S block plays a role of stabilizing an input signal; and the register at an output of the S2S block plays a role of stabilizing an output signal. An output register of an upstream S2S block may be an input register of one or more downstream S2S blocks. What betweens the input register and the output register of the S2S block is just an intermediate portion, which includes at least one combinational cell such as AND gate, OR gate, NAND gate, XOR gate, etc. These combinational cells process a signal input into the S2S block via the input register, and then output the signal via the output register.

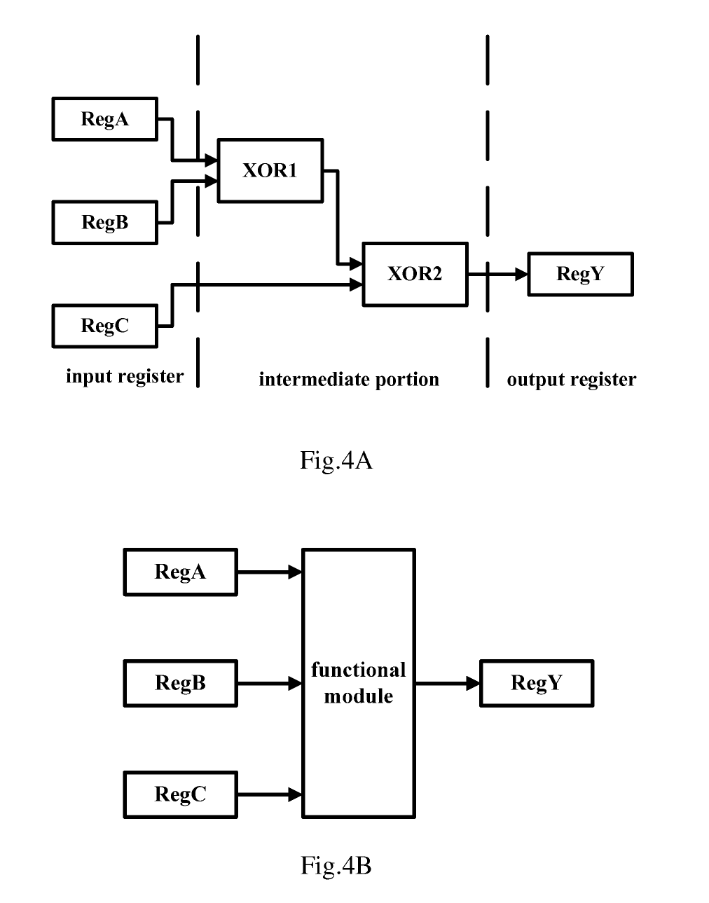

FIG. 4A shows an exemplary S2S block, wherein, RegA, RegB and RegC are input registers, RegY is an output register, XOR1 and XOR2 as well as respective connections are combinational cells.

A S2S block in a circuit may be identified through sequential cell detection and logic path traversal, wherein, the sequential cell detection is used to identify sequential cells (e.g., registers) in a circuit design. For a cell in the circuit design, if it includes timing check constrains such as setup time and hold time, that cell is identified as a sequential cell. This is to ensure that after processing according to embodiment of the present invention has been performed on the circuit design, simulation for the circuit design still can find errors in timing. Those skilled in the art will appreciate that, after the sequential cells are identified, remaining cells in the circuit design are just combinational cells.

After sequential cell detection is performed, the combinational cell between any two adjacent sequential cells can be readily determined, thus constructing a basic S2S block. The adjacent sequential cells refer to that there is no other sequential cell between these two sequential cells. For example, starting from an input of a sequential cell, cells being passed in a direction against signal flow may be obtained one by one, until another sequential cell is passed; or starting from an output of a sequential cell, cells being passed along a direction of the signal flow may be obtained one by one, until another sequential cell is passed; or starting from an input and an output of a combinational cell, cells may be obtained respectively in the direction against the signal flow and along the direction of the signal flow, until a first sequential cell is passed.

For example, in a structure as shown in FIG. 4A, a basic S2S block comprised of RegA, XOR1, XOR2 and RegY and related connections may be obtained in accordance with the above described method. The combinational cells in the above-described basic S2S block may further involve other sequential cells, for example, XOR1 further involves RegB, and XOR2 further involves RegC. The basic S2S block is extended to become the S2S block as shown in FIG. 4A.

Step 302: determining logic characteristics and timing characteristics of the intermediate portion.

Those skilled in the art may appreciate that, all possible states of the input registers and the output registers of the S2S block may be denoted by a truth table, so as to denote the logic characteristics of the intermediate portion. The truth table of the intermediate portion shown in FIG. 4A is as follows:

| RegA | RegB | RegC | RegY |
|---|---|---|---|
| 0 | 0 | 0 | 0 |
| 0 | 0 | 1 | 1 |
| 0 | 1 | 0 | 1 |
| 0 | 1 | 1 | 0 |
| 1 | 0 | 0 | 1 |
| 1 | 0 | 1 | 0 |
| 1 | 1 | 0 | 0 |
| 1 | 1 | 1 | 1 |

How to determine the truth table of a combinational logic circuit belongs to technical means commonly used in the art, which will not be repeated herein.

How to determine timing characteristics of the intermediate portion will be further described below with reference to other drawings.

Step 303: replacing the intermediate portion with a functional module having the logic characteristics and the timing characteristics to generate a simplified circuit design to be used in simulation.

Since the functional module and the intermediate portion have the same logic characteristics and timing characteristics, in theory, simulation results of the circuit design before and after simplification are the same. In particular, since the functional module does not include sequential cell, timing characteristics of the circuit can still be considered in simulation.

FIG. 4B shows a S2S block after replacing the intermediate portion with a functional module.

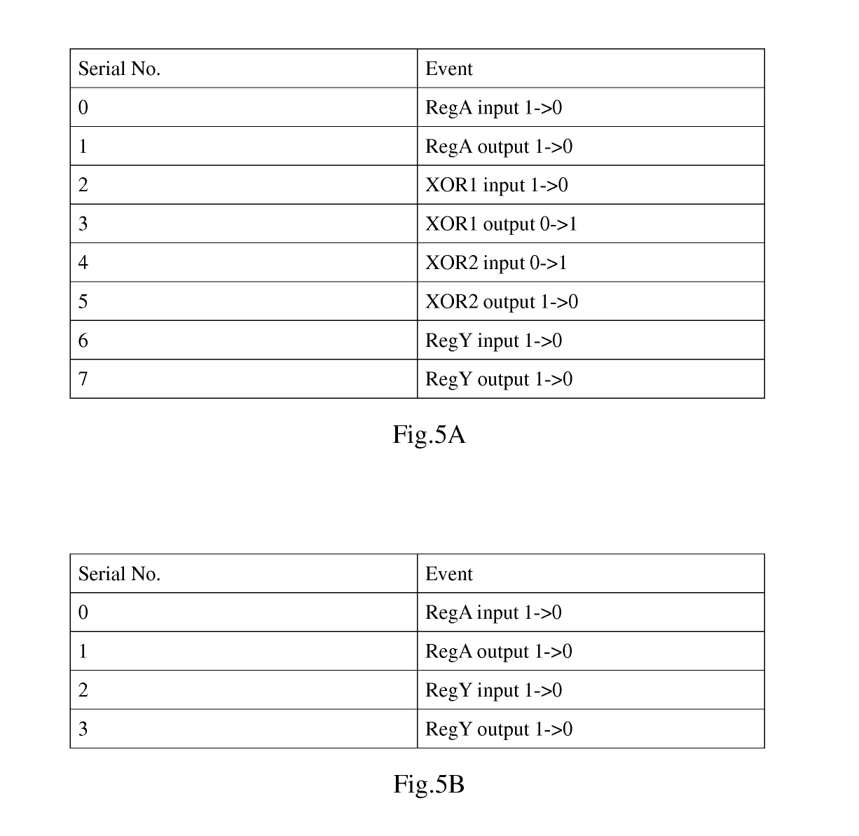

After replacing the intermediate portion with the functional module, since number of cells in the circuit is reduced, simulation time is shortened. Why simulation time can be shortened after replacing the intermediate portion with the functional module is further explained below with reference to FIG. 5A and FIG. 5B. In FIG. 5A and FIG. 5B, simulation starts when input of RegA changes from 1 to 0, and ends till a response change occurs at output of RegY. During the simulation, values of RegB and RegC are kept as 1.

FIG. 5A shows an event list in simulation of the circuit design shown in FIG. 4A. It can be seen from FIG. 5A that the number of events needs to be processed to complete the simulation is 8. FIG. 5B shows an event list in simulation of the circuit design shown in FIG. 4B. As can be seen from FIG. 5B, such an event as output of RegA directly leads to such an event as input of RegY, so that number of events necessary for completion of simulation becomes 4. This is because such combinational cells as a connection between RegA and XOR1, XOR1, a connection between XOR1 and XOR2, and a connection between XOR2 and RegY are replaced by the functional module having equivalent logic characteristics and timing characteristics. Accordingly, an input value of RegY corresponding to an output value of RegA can be directly found out from the logic characteristics of the obtained intermediate portion; and the timing characteristics that need to be considered from the output of RegA to the input of RegY can be directly found out from the timing characteristics of the obtained intermediate portion.

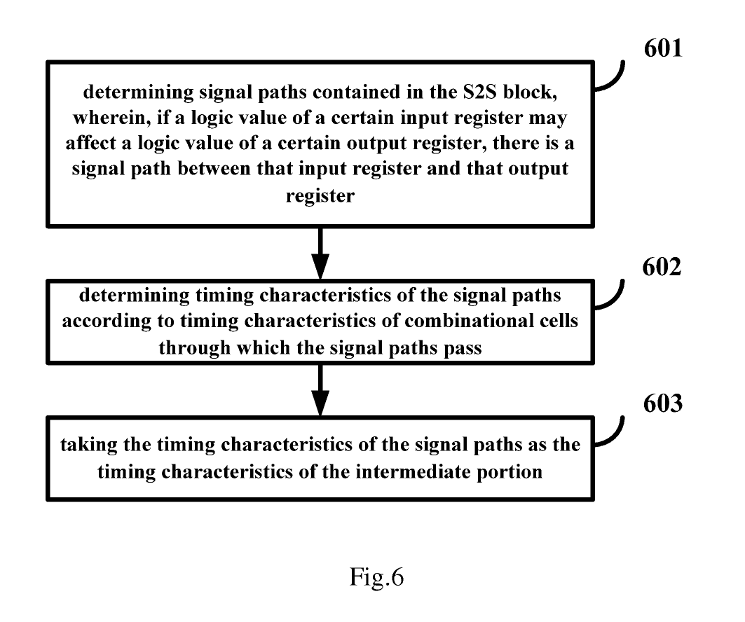

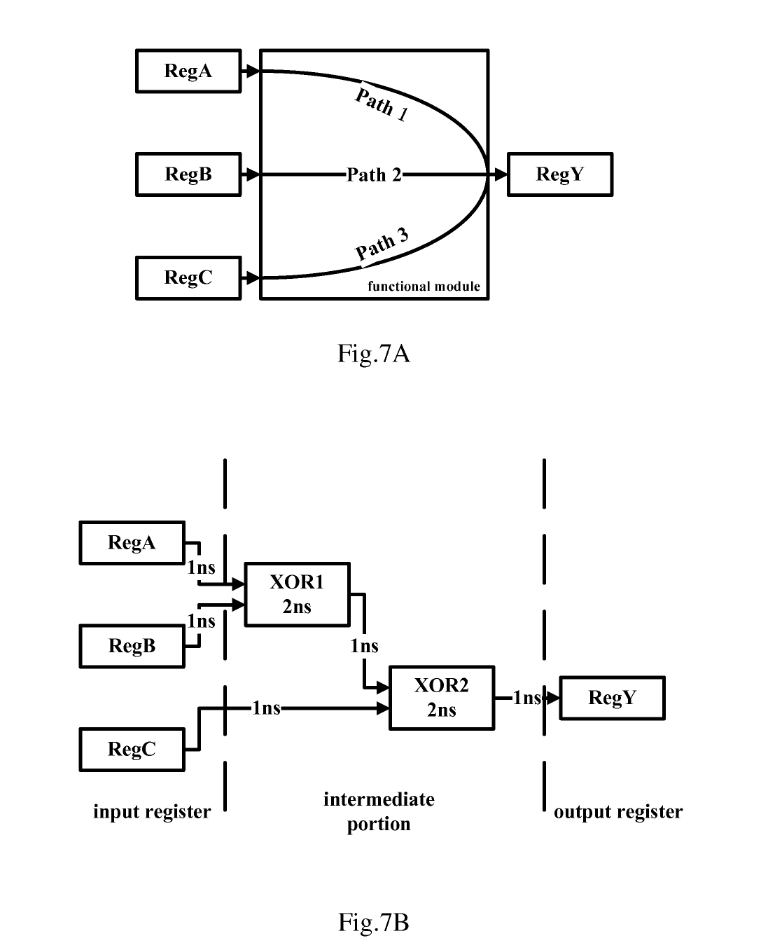

How to determine the timing characteristics of the intermediate portion will be described below with reference to FIG. 6 and FIG. 7A-FIG. 7B.

Step 601: determining signal paths contained in the S2S block, wherein, if a logic value of a certain input register may affect a logic value of a certain output register, there is a signal path between that input register and that output register.

In the S2S block shown in FIG. 4A, logic values of RegA, RegB and RegC can respectively affect the logic value of RegY. Thus, in the S2S block, there are three signal paths, which are Path 1, Path 2 and Path 3 respectively, as shown in FIG. 7A.

Step 602: determining timing characteristics of the signal paths according to timing characteristics of combinational cells through which the signal paths pass.

The signal paths are located between the input register and the output register, and they only pass through the combinational cells, so the timing characteristics of the signal paths are determined by the timing characteristics of the combinational cells through which the signal paths pass. Those skilled in the art may appreciate that, the timing characteristics of a given combinational cell may be regarded as a constant. Accordingly, the timing characteristics of the signal paths may also be regarded as a constant.

FIG. 7B and FIG. 7C illustrate, by taking delay characteristics in the timing characteristics for example, determination of the timing characteristics of the signal paths according to the timing characteristics of the combinational cells through which the signal paths pass. In FIG. 7B, delay characteristics of respective combinational cells are annotated. In FIG. 7C, delay characteristics of respective signal paths are annotated. Those skilled in the art will readily appreciate that, the delay of Signal Path 1 is a sum of the delay of the following respective combinational cells: a connection between RegA and XOR1, XOR1, a connection between XOR1 and XOR2, XOR2, as well as a connection between XOR2 and RegY. The delay of Signal Path 2 is a sum of the delay of the following respective combinational cells: a connection between RegB and XOR1, XOR1, a connection between XOR1 and XOR2, XOR2, as well as a connection between XOR2 and RegY. The delay of Signal Path 3 is a sum of the delay of the following respective combinational cells: a connection between RegC and XOR2, XOR2, as well as a connection between XOR2 and RegY.

Step 603: taking the timing characteristics of the signal paths as the timing characteristics of the intermediate portion.

As described above, during simulation of the simplified circuit design, the output (Event 1 in FIG. 5B) of the input register RegA of the S2S block directly triggers the input (Event 2 in FIG. 5B) of the output register RegY of the S2S block. However, a timing issue between the two events still needs to be considered. Still taking the delay characteristics for example, as can be seen from FIG. 7C, the signal path between RegA and RegY corresponds to a delay of 7 ns. That is to say, during the simulation of the simplified circuit design, the event of RegY input only occurs at 7 ns after the event of RegA output.

In contrast, during simulation of the circuit design before simplification, output of RegA (Event 1 in FIG. 5A) triggers input of RegY (Event 6 in FIG. 5B) only after passing input of XOR1 (Event 2 in FIG. 5A), output of XOR1 (Event 3 in FIG. 5A), input of XOR2 (Event 4 in FIG. 5A), and input of XOR2 (Event 5 in FIG. 5A). As can be seen from FIG. 7B, the delay from Event 1 to Event 2 is 1 ns, the delay from Event 2 to Event 3 is 2 ns, the delay from Event 3 to Event 4 is 1 ns, the delay from Event 4 to Event 5 is 2 ns, the delay from Event 5 to Event 6 is 2 ns. That is to say, during simulation of the circuit design before simplification, the event of RegY input also only occurs at 7 ns after the event of RegA output. It is seen that, by replacing the intermediate portion with the functional module during simulation, with the timing characteristics of the functional module and the timing characteristics of the intermediate portion being the same, the obtained simulation result is equivalent to that of the original circuit design.

As can be seen from the above analysis, in the simplified circuit design, number of circuit cells is reduced. Accordingly, both number of circuit cells and number of events to be processed during simulation are reduced, thus time required for simulation is shortened.

In the above description, the intermediate portion replaced by the functional module merely comprises combinational cells and does not comprise sequential cell. As described before, this is to ensure that timing characteristics (especially, setup time, hold time, etc.) of the sequential cell can be considered during simulation. If the sequential cell is also included in the intermediate portion replaced by the functional module, then these timing characteristics of that sequential cell may not get simulated.

A device according to an embodiment of the present invention typically can be implemented by a computer program running on the exemplary computer system shown in FIG. 1. Although what is shown in FIG. 1 is a hardware configuration of a general-purpose computer system, since the computer system runs the computer program, it implements a solution according to the embodiment of the present invention, such that the computer system/server is turned from a general-purpose computer system/server into the device according to the embodiment of the present invention.

In addition, although the device according to an embodiment of the present invention as a whole is implemented by the same general-purpose computer system, respective means or modules that constitute the device are essentially implemented by discrete hardware. This is because when running the computer program, the general-purpose computer typically implements respective means or modules in a sharing mode such as time sharing or processor core sharing. Taking implementation of time sharing for example, at a particular point in time, the general-purpose computer system serves as a dedicated hardware for implementing a specific means or module; at different points of time, the general-purpose computer system serves as different hardware dedicated for implementing different means or modules. Thus, the device according to the embodiment of the present invention is a combination of a series of means or modules implemented in a hardware manner, which is not merely functional module architecture. Rather, the device according to the embodiment of the present invention can also be construed as a physical device that implements the solution according to the embodiment of the present invention mainly in a hardware manner.

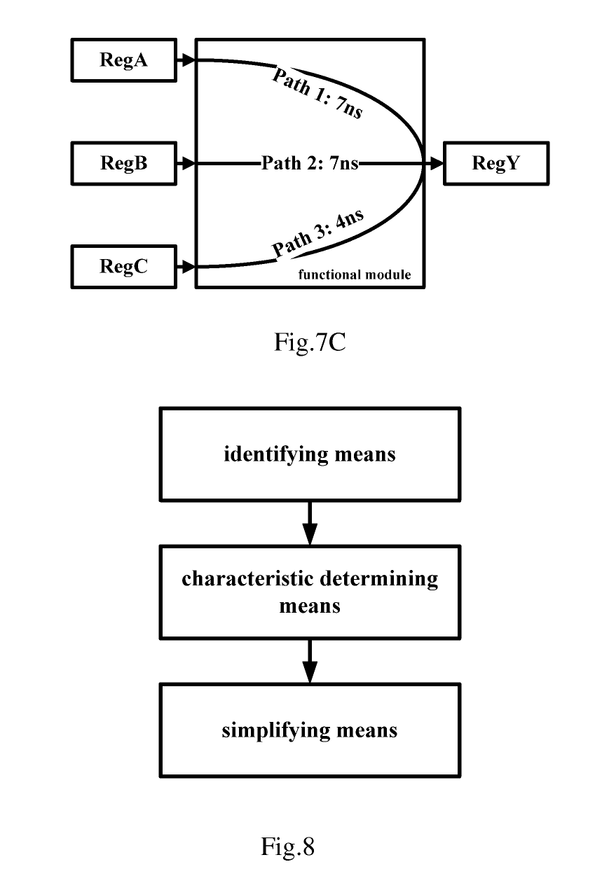

FIG. 8 shows a device for simulating a circuit design according to an embodiment of the present invention, the device comprising:

an identifying means configured to identify at least one Sequential-cell-To-Sequential-cell (S2S) block in the circuit design, wherein the S2S block includes at least one input sequential cell, at least one output sequential cell, and an intermediate portion between the input sequential cell and the output sequential cell, and wherein the intermediate portion includes at least one combinational cell;

a characteristic determining means configured to determine logic characteristics and timing characteristics of the intermediate portion; and

a simplifying means configured to replace the intermediate portion with a functional module having the logic characteristics and the timing characteristics to generate a simplified circuit design to be used in simulation.

Wherein the characteristic determining means comprises:

a module configured to obtain all possible states of the input sequential cell and the output sequential cell of the S2S block, so as to determine the logic characteristics of the intermediate portion.

Wherein the characteristic determining means comprises:

a module configured to determine signal paths contained in the S2S block, wherein, if a logic value of a certain input sequential cell may affect a logic value of a certain output sequential cell, there is a signal path between that input sequential cell and that output sequential cell;

a module configured to determine timing characteristics of the signal paths according to timing characteristics of cells through which the signal paths pass; and

a module configured to take the timing characteristics of the signal paths as the timing characteristics of the intermediate portion.

Wherein, the intermediate portion only includes combinational cell(s).

Wherein the identifying means comprises:

a module configured to identify sequential cells in the circuit, wherein the sequential cells include timing check constrains;

a module configured to determine any two adjacent sequential cells;

a module configured to determine combinational cells between the two adjacent sequential cells; and

a module configured to determine the two adjacent sequential cells and the combinational cells therebetween as a S2S block.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for simulating a circuit design, comprising:
identifying at least one Sequential-cell-To-Sequential-cell (S2S) block in the circuit design, wherein the S2S block includes at least one input sequential cell, at least one output sequential cell, and an intermediate portion between the input sequential cell and the output sequential cell, wherein the intermediate portion includes at least one combinational cell;
determining logic characteristics and timing characteristics of the intermediate portion;
replacing the intermediate portion with a functional module having the logic characteristics and the timing characteristics of the intermediate portion to generate a simplified circuit design; and
performing simulation using the simplified circuit design.

2. The method according to claim 1, wherein the step of determining logic characteristics and timing characteristics of the intermediate portion comprises:
obtaining possible states of the input sequential cell and the output sequential cell of the S2S block, so as to determine the logic characteristics of the intermediate portion.

3. The method according to claim 1, wherein the step of determining logic characteristics and timing characteristics of the intermediate portion comprises:
determining signal paths contained in the S2S block, wherein, if a logic value of a certain input sequential cell affects a logic value of a certain output sequential cell, a signal path is defined between that certain input sequential cell and that certain output sequential cell;
determining timing characteristics of the signal paths according to timing characteristics of cells through which the signal paths pass; and
taking the timing characteristics of the signal paths as the timing characteristics of the intermediate portion.

4. The method according to claim 1, wherein the intermediate portion only includes one or more combinational cells.

5. The method according to claim 4, wherein the step of identifying at least one S2S block in the circuit design comprises:
identifying sequential cells in the circuit design, wherein the sequential cells include timing check constrains;
determining any two adjacent sequential cells;
determining combinational cells between the two adjacent sequential cells; and
treating the two adjacent sequential cells and the combinational cells therebetween as a S2S block.

6. A device for simulating a circuit design, comprising:
an identifying means configured to identify at least one Sequential-cell-To-Sequential-cell (S2S) block in the circuit design, wherein the S2S block includes at least one input sequential cell, at least one output sequential cell, and an intermediate portion between the input sequential cell and the output sequential cell, wherein the intermediate portion includes at least one combinational cell;
a characteristic determining means configured to determine logic characteristics and timing characteristics of the intermediate portion; and
a simplifying means configured to replace the intermediate portion with a functional module having the logic characteristics and the timing characteristics to generate a simplified circuit design to be used in simulation.

7. The device according to claim 6, wherein the characteristic determining means comprises:
a module configured to obtain possible states of the input sequential cell and the output sequential cell of the S2S block, so as to determine the logic characteristics of the intermediate portion.

8. The device according to claim 6, wherein the characteristic determining means comprises:
a module configured to determine signal paths contained in the S2S block, wherein, if a logic value of a certain input sequential cell affects a logic value of a certain output sequential cell, it is determined a signal path exist between that certain input sequential cell and that certain output sequential cell;
a module configured to determine timing characteristics of the signal paths according to timing characteristics of cells through which the signal paths pass; and
a module configured to take the timing characteristics of the signal paths as the timing characteristics of the intermediate portion.

9. The device according to claim 6, wherein the intermediate portion only includes one or more combinational cells.

10. The device according to claim 9, wherein the identifying means comprises:
a first module configured to identify sequential cells in the circuit design, wherein the sequential cells include timing check constrains;
a second module configured to determine any two adjacent sequential cells;
a third module configured to determine combinational cells between the two adjacent sequential cells; and
a fourth module configured to treat the two adjacent sequential cells and the combinational cells therebetween as a S2S block.
